(19) United States
(12) Patent Application Publication
(10) Pub. No.: US 2019/0124647 A1
(43) Pub. Date: Apr. 25, 2019

(54) CONFIGURATION AND SELECTION OF PUCCH RESOURCE SET

(71) Applicant: Mediatek Inc., Hsin-Chu (TW)

(72) Inventor: Xiu-Sheng Li, Hsinchu (TW)

(21) Appl. No.: 16/166,327

(22) Filed: Oct. 22, 2018

Related U.S. Application Data
(60) Provisional application No. 62/575,584, filed on Oct. 23, 2017.

(51) Int. Cl. H04W 72/04; H04W 76/27; H04L 1/18; H04L 5/00

(52) U.S. Cl. CPC H04W 72/0413; H04L 5/0044; H04L 1/1812; H04W 76/27

(57) ABSTRACT

A method, a computer-readable medium, and an apparatus are provided. The apparatus may be a UE. The UE determines a size of an uplink control information (UCI) payload of the UE to be transmitted to a base station. The UE selects, based on the size, a first collection from a first group of collections of physical uplink control channel (PUCCH) resource sets, each collection of the first group of collections corresponding to a respective different UCI payload size range, each PUCCH resource set including one or more resource candidates. The UE selects a first PUCCH resource set from the first collection of PUCCH resource sets. The UE selects a first resource candidate from one or more resource candidates of the first PUCCH resource set based on a first indication received from the base station. The UE transmits the UCI payload to the base station in the first resource candidate.

### CROSS-REFERENCE TO RELATED APPLICATION(S)

This application claims the benefits of U.S. Provisional Application Ser. No. 62/575,584, entitled “CONFIGURATION AND SELECTION OF SET OF PUCCH RESOURCE IN NR” and filed on Oct. 23, 2017, which is expressly incorporated by reference herein in their entirety.

### BACKGROUND

### Field

The present disclosure relates generally to communication systems, and more particularly, to techniques for resource allocation for control information in physical channel employed by a user equipment (UE).

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE. The UE determines a size of an uplink control information (UCI) payload of the UE to be transmitted to a base station. The UE selects, based on the size, a first collection from a first group of collections of physical uplink control channel (PUCCH) resource sets, each collection of the first group of collections corresponding to a respective different UCI payload size range, each PUCCH resource set including one or more resource candidates. The UE selects a first PUCCH resource set from the first collection of PUCCH resource sets. The UE selects a first resource candidate from one or more resource candidates of the first PUCCH resource set based on a first indication received from the base station. The UE transmits the UCI payload to the base station in the first resource candidate.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric subframe.

FIG. 6 is a diagram showing an example of an UL-centric subframe.

FIG. 7 is a diagram illustrating communications between a UE and a base station.

FIG. 8 is a diagram illustrating techniques of selecting a PUCCH resource candidate from a PUCCH resource set.

FIG. 9 is a diagram illustrating techniques of selecting a PUCCH resource candidate from multiple PUCCH resource sets.

FIG. 10 is another diagram illustrating techniques of selecting a PUCCH resource candidate from multiple PUCCH resource sets.

FIG. 11 is another diagram illustrating techniques of selecting a PUCCH resource candidate from multiple PUCCH resource sets.

FIG. 12 is a diagram illustrating an embodiment of a technique to determine the set of PUCCH resource to be indicated in DCI.

FIG. 13 is a diagram illustrating another embodiment of a technique to determine the set of PUCCH resource to be indicated in DCI.

FIG. 14 is a diagram illustrating yet another embodiment of a technique to determine the set of PUCCH resource to be indicated in DCI.

FIG. 15 is a diagram illustrating an embodiment of a technique to determine the set of PUCCH resource to be indicated in DCI.

FIG. 16 is a diagram illustrating an embodiment of a technique to determine the set of PUCCH resource to be indicated in DCI.

FIG. 17 is a diagram illustrating an embodiment of a technique to determine the set of PUCCH resource to be indicated in DCI.

FIG. 18 is a flow chart illustrating a method (process) of determining a PUCCH resource set.

FIG. 19 is a conceptual data flow diagram illustrating the data flow between different components/means in an exemplary apparatus.

FIG. 20 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

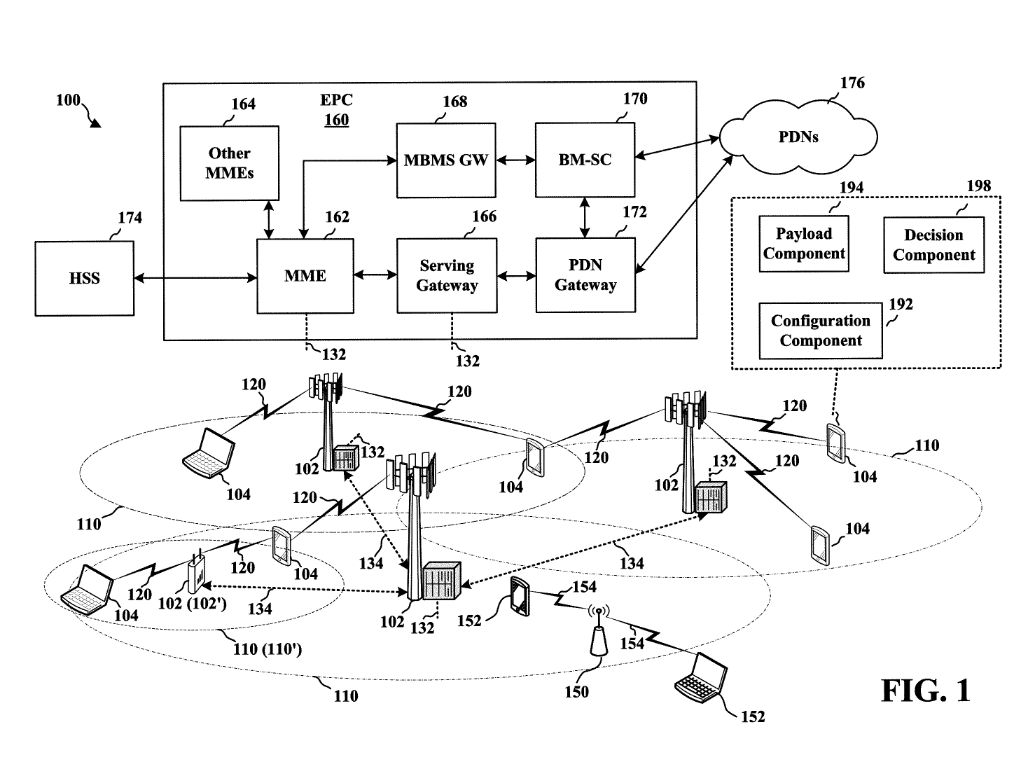

FIG. 1 is a diagram illustrating an example of a wireless communications system and an access network 100. The wireless communications system (also referred to as a wireless wide area network (WWAN)) includes base stations 102, UEs 104, and an Evolved Packet Core (EPC) 160. The base stations 102 may include macro cells (high power cellular base station) and/or small cells (low power cellular base station). The macro cells include base stations. The small cells include femtocells, picocells, and microcells.

The base stations 102 (collectively referred to as Evolved Universal Mobile Telecommunications System (UMTS) Terrestrial Radio Access Network (E-UTRAN)) interface with the EPC 160 through backhaul links 132 (e.g., S1 interface). In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100 MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

The gNodeB (gNB) 180 may operate in millimeter wave (mmW) frequencies and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 184 with the UE 104 to compensate for the extremely high path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service (PSS), and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The base station may also be referred to as a gNB, Node B, evolved Node B (eNB), an access point, a base transceiver station, a radio base station, a radio transceiver, a transceiver function, a basic service set (BSS), an extended service set (ESS), or some other suitable terminology. The base station 102 provides an access point to the EPC 160 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a toaster, or any other similar functioning device. Some of the UEs 104 may be referred to as IoT devices (e.g., parking meter, gas pump, toaster, vehicles, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

In certain aspects, the UE 104 includes, among other components, a configuration component 192, a payload component 194, and a decision component 198. The payload component 194 determines a size of an uplink control information (UCI) payload of the UE to be transmitted to a base station. The decision component 198 selects, based on the size, a first collection from a first group of collections of physical uplink control channel (PUCCH) resource sets, each collection of the first group of collections corresponding to a respective different UCI payload size range, each PUCCH resource set including one or more resource candidates. The decision component 198 selects a first PUCCH resource set from the first collection of PUCCH resource sets. The decision component 198 selects a first resource candidate from one or more resource candidates of the first PUCCH resource set based on a first indication received from the base station. The UE 104 transmits the UCI payload to the base station in the first resource candidate.

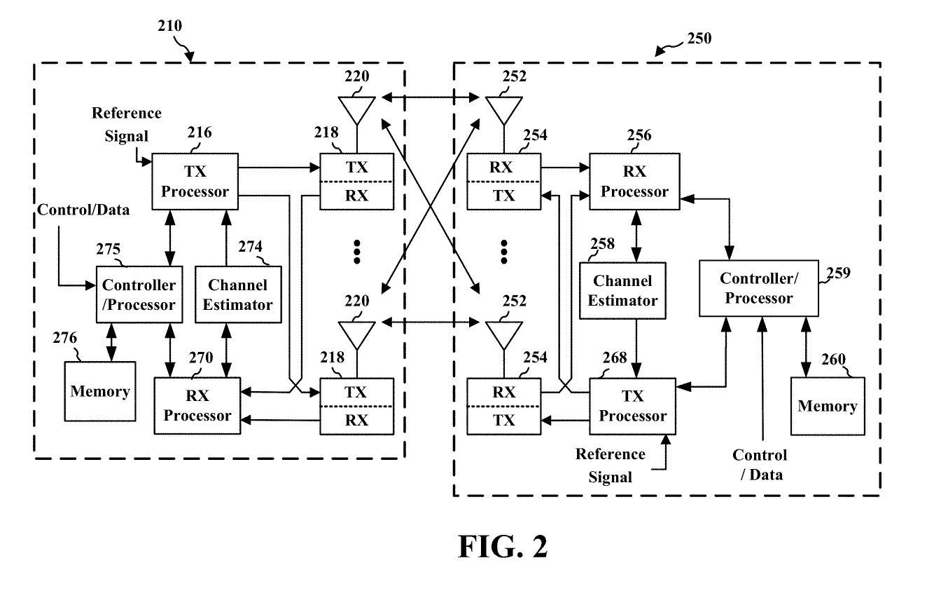

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g., 80 MHz beyond), millimeter wave (mmW) targeting high carrier frequency (e.g., 60 GHz), massive MTC (mMTC) targeting non-backward compatible MTC techniques, and/or mission critical targeting ultra-reliable low latency communications (URLLC) service.

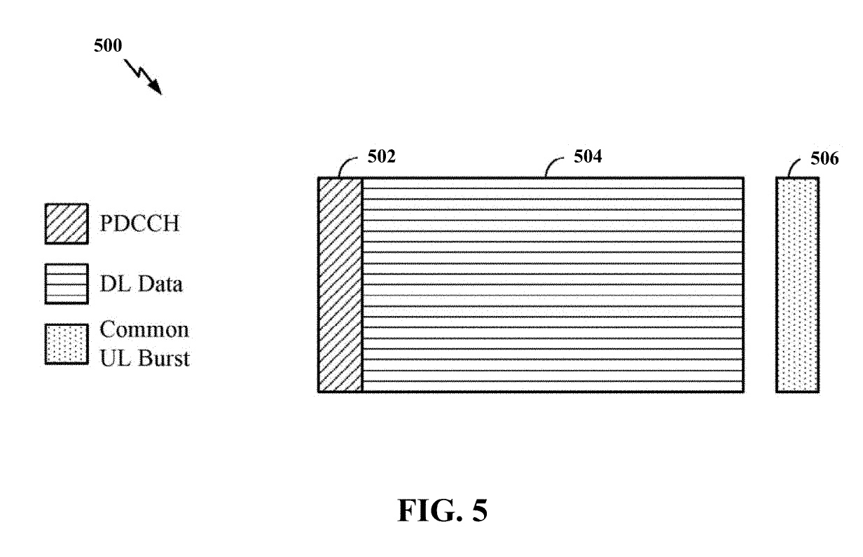

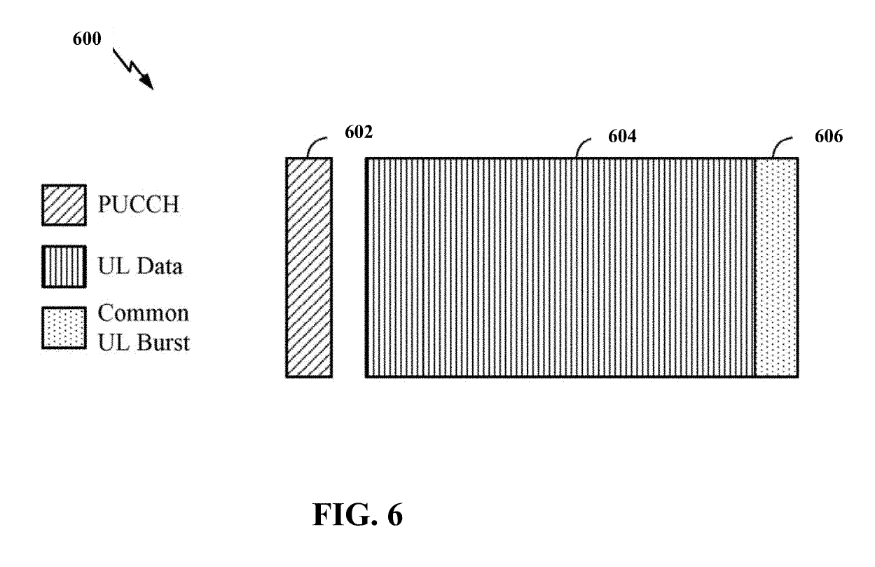

A single component carrier bandwidth of 100 MHZ may be supported. In one example, NR resource blocks (RBs) may span 12 sub-carriers with a sub-carrier bandwidth of 60 kHz over a 0.125 ms duration or a bandwidth of 15 kHz over a 0.5 ms duration. Each radio frame may consist of 20 or 80 subframes (or NR slots) with a length of 10 ms. Each subframe may indicate a link direction (i.e., DL or UL) for data transmission and the link direction for each subframe may be dynamically switched. Each subframe may include DL/UL data as well as DL/UL control data. UL and DL subframes for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

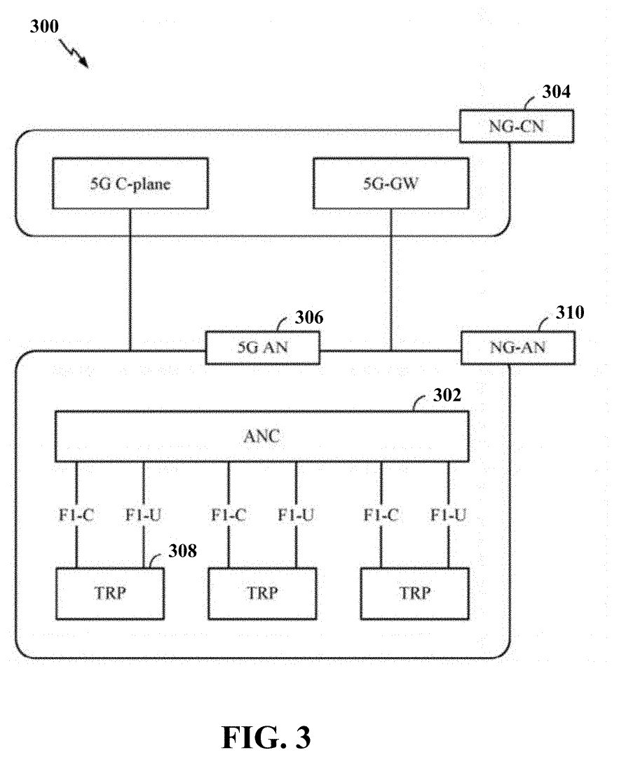

FIG. 3 illustrates an example logical architecture 300 of a distributed RAN, according to aspects of the present disclosure. A 5G access node 306 may include an access node controller (ANC) 302. The ANC may be a central unit (CU) of the distributed RAN 300. The backhaul interface to the next generation core network (NG-CN) 304 may terminate at the ANC. The backhaul interface to neighboring next generation access nodes (NG-ANs) may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific AND deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

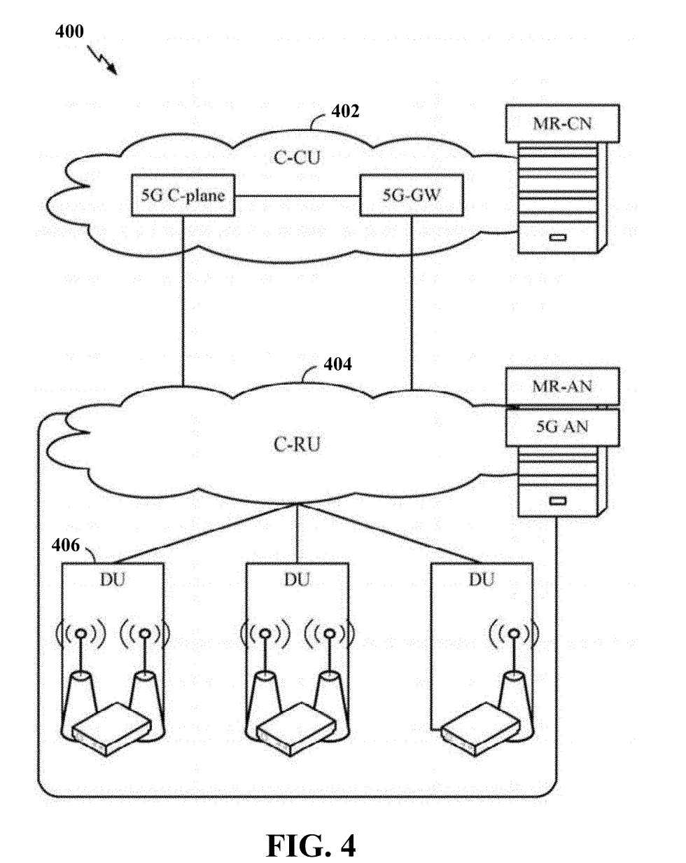

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric subframe. The DL-centric subframe may include a control portion 502. The control portion 502 may exist in the initial or beginning portion of the DL-centric subframe. The control portion 502 may include various scheduling information and/or control information corresponding to various portions of the DL-centric subframe. In some configurations, the control portion 502 may be a physical DL control channel (PDCCH), as indicated in FIG. 5. The DL-centric subframe may also include a DL data portion 504. The DL data portion 504 may sometimes be referred to as the payload of the DL-centric subframe. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric subframe may also include a common UL portion 506. The common UL portion 506 may sometimes be referred to as an UL burst, a common UL burst, and/or various other suitable terms. The common UL portion 506 may include feedback information corresponding to various other portions of the DL-centric subframe. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric subframe and alternative structures having similar features may exist without necessarily deviating from the aspects described herein.

FIG. 6 is a diagram 600 showing an example of an UL-centric subframe. The UL-centric subframe may include a control portion 602. The control portion 602 may exist in the initial or beginning portion of the UL-centric subframe. The control portion 602 in FIG. 6 may be similar to the control portion 502 described above with reference to FIG. 5. The UL-centric subframe may also include an UL data portion 604. The UL data portion 604 may sometimes be referred to as the pay load of the UL-centric subframe. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric subframe may also include a common UL portion 606. The common UL portion 606 in FIG. 6 may be similar to the common UL portion 606 described above with reference to FIG. 6. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric subframe and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

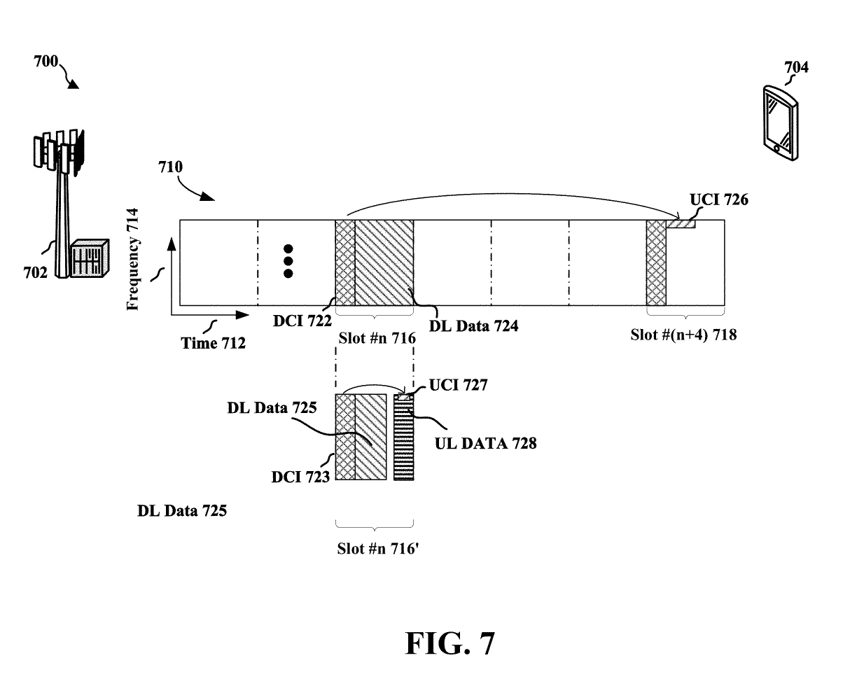

FIG. 7 is a diagram 700 illustrating communications between a UE 704 and a base station 702. In particular, the base station 702 and the UE 704 may communicate in multiple slots 710. In one configuration, the base station 702 assigns PDSCH and PUSCH transmission in the multiple slots 710 based on slots. In other words, each of the multiple slots 710 is either DL-centric or UL-centric as described supra with respect to FIGS. 5-6. In this example, the slot #n 716 is a DL-centric slot. The base station 702 transmits DCI 722 in PDCCH of the slot #n 716 and DL data 724 in the PDSCH of the slot #n 716. The DCI 722 indicates, among other things, a location of a PUCCH in a UL-centric slot for transmitting UCI 726 associated with the DL data 724 of the slot #n 716. In this example, the associated UL-centric slot is slot #(n+4) 718. The UCI 726 may include a scheduling request (SR), a hybrid automatic repeat request (HARQ) acknowledgment (ACK)/negative acknowledgment (NACK) and a CQI etc.

In another configuration, the base station 702 assigns PDSCH and PUSCH transmissions in the multiple slots 710 based on symbols (i.e., non-slot based). The PDSCH and the PUSCH may be assigned in the same slot. For example, a slot #n 716′ may include a first region for transmitting DCI 723, a second region for transmitting DL data 725, and a third region for transmitting UL data 728. The DCI 723 indicates, among other things, a location of a PUCCH in the third region for transmitting UCI 727 associated with the DL data 725.

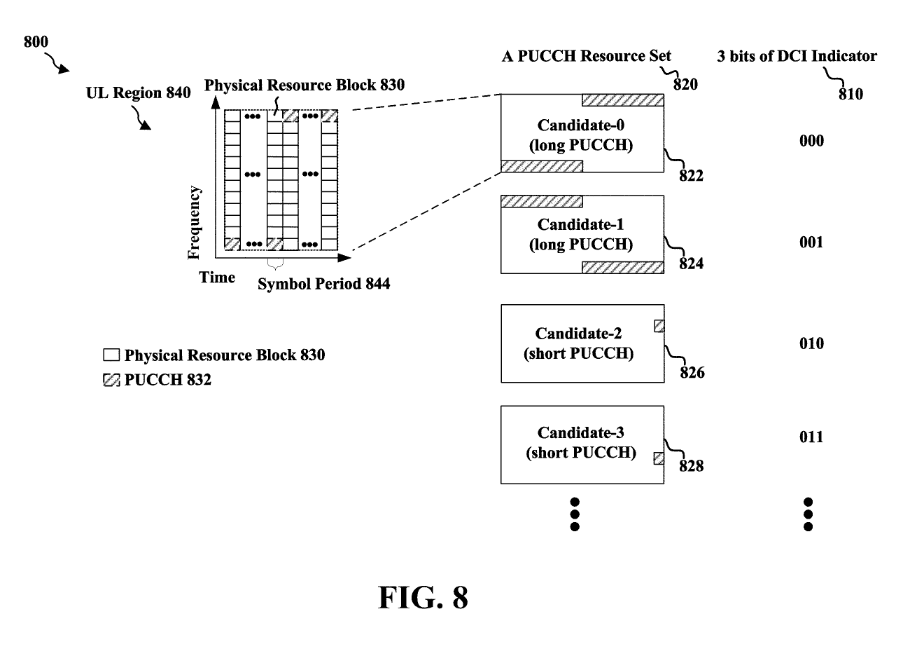

FIG. 8 is a diagram 800 illustrating techniques of selecting a PUCCH resource candidate from a PUCCH resource set. As described supra, the DCI 722 indicate a location and other information of a PUCCH associated with the DL data 724. (The DCI 725 similarly indicates the location and other information of a PUCCH associated with the DL data 725.) In particular, the base station 702 may send a configuration to the UE 704 specifying a PUCCH resource set 820 that include multiple PUCCH resource candidates in a particular UL region 840 (e.g., the UL region in the slot #(n+4) 718 or in the slot #n 716′). For simplicity, FIG. 8 only illustrates four PUCCH resource candidates: PUCCH resource candidate-0 822, PUCCH candidate-1 824, PUCCH candidate-2 826 and the PUCCH resource candidate-3 828. The base station 702 may include a DCI indicator 810 in the DCI 722 to indicate a particular candidate in the PUCCH resource set 820 to use for transmitting the UCI 726. In this example, the DCI 722 has 3 bits and, thus, can identify one particular PUCCH resource candidate from 8 PUCCH resource candidates (PUCCH resource candidate-0 822, PUCCH candidate-1 824, PUCCH candidate-2 826 and the PUCCH resource candidate-3 828, . . . ). For example, when the 3 bits of DCI indicator 810 is 000, it identifies the PUCCH resource candidate-0 822; when the 3 bits of DCI indicator 810 is 011, it identifies the PUCCH resource candidate-3 828. It should be noted that the DCI indicator 810 may have a different number bit (e.g., 2 bits or 4 bits) in other examples.

Further, each PUCCH resource candidate may use a particular format. In this example, the formats of the PUCCH resource candidate-0 822 and the PUCCH resource candidate-1 824 are long PUCCH, and the formats of the PUCCH resource candidate-2 826 and the PUCCH resource candidate-3 828 are short PUCCH. Further, each PUCCH resource candidate is defined by number and location of physical resource blocks (PRBs) 830 in the frequency domain and number of location of symbol periods 844 (e.g., OFDM symbols) in the time domain. Each PRB 830 may include multiple subcarriers (e.g., 12 subcarriers) in a single symbol period. The PUCCH resource candidate is also defined by a code index of the orthogonal code employed.

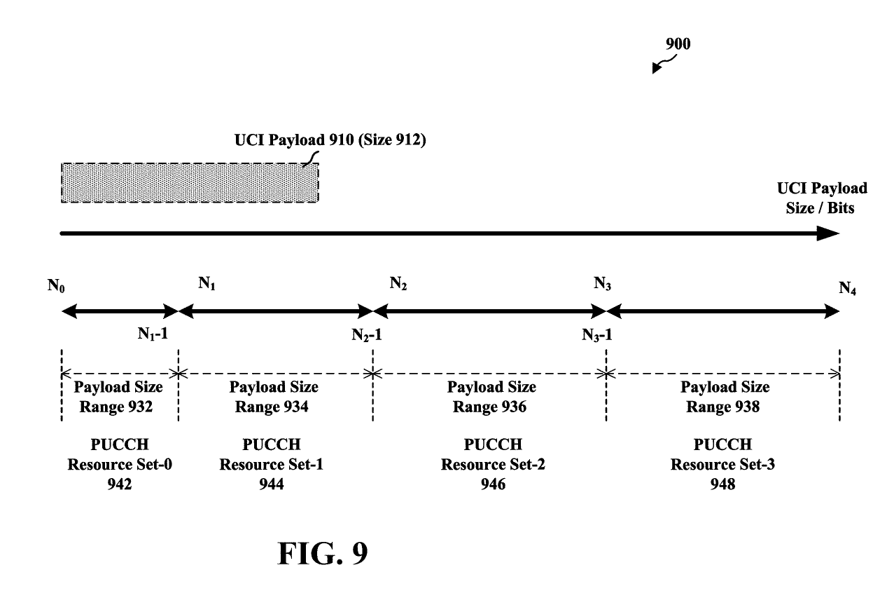

FIG. 9 is a diagram 900 illustrating techniques of selecting a PUCCH resource candidate from multiple PUCCH resource sets. In certain configurations, the UE 704 may receive from the base station 702 a configuration that specifies multiple PUCCH resource sets in the UL region 840. Further, the UE 704 has a UCI payload 910 to be transmitted to the base station 702 in a PUCCH resource candidate selected from the multiple PUCCH resource sets. Both the UE 704 and the base station 702 knows a size 912 of the UCI payload 910. In this technique, the UE 704 can select a particular PUCCH resource set from the multiple PUCCH resource sets based on the size 912. Subsequently, the UE 704 can select a PUCCH resource candidate from the particular PUCCH resource set based on the DCI indicator 810 as described supra.

More specifically, the UE 704 may determine the size 912 of the UCI payload 910 in bits. Further, based on the configuration received from the base station 702, the UE 704 divides the possible size 912 into multiple payload size ranges. In this example, the possible size 912 is divided into four ranges: a payload size range 932, a payload size range 934, a payload size range 936 and a payload size range 938. The payload size range 932 is from N₀ bits to (N₁−1) bits. The payload size range 934 is from N₀ bits to (N₁−1) bits. The payload size range 936 is from N₂ bits to (N₃−1) bits. The payload size range 938 is from N₃ bits to N₄ bits. One example of N₀, N₁, N₂ and N₃ is 1, 3, 12 and 50. N₄ may be infinity. The payload size range 932 corresponds to a PUCCH resource set-0 942. Accordingly, when the size 912 is in the payload size range 932, the UE 704 selects the PUCCH resource set-0 942 as the particular PUCCH resource set from which a PUCCH resource candidate is determined based on the DCI indicator 810. Similarly, the payload size range 934 corresponds to a PUCCH resource set-1 944. The payload size range 936 corresponds to a PUCCH resource set-2 946. The payload size range 938 corresponds to a PUCCH resource set-3 948.

For each of the four PUCCH resource sets 942 to 948, there are multiple PUCCH resource candidates. For example, the PUCCH resource set-0 942 may have eight PUCCH resource candidates as shown in FIG. 8. The UE 704 may receive a configuration from the base station 702, and the configuration may indicate the number of PUCCH resource sets (e.g., four), the respective payload size ranges (e.g., the payload size ranges 932 to 938), and the one or more PUCCH resource candidates of each PUCCH resource set (e.g., the PUCCH resource set-0 942). Based on the information in the configuration received from the base station 702, the UE 704 can select a particular PUCCH resource set based on the size 912, and further select a particular PUCCH resource candidate from the selected PUCCH resource set based on the DCI indicator 810.

Both PUCCH resource candidates with a long PUCCH format such as the PUCCH resource candidate-0 822 and PUCCH resource candidates with a short PUCCH format such as the PUCCH resource candidate-2 826 can be configured in each PUCCH resource set. In case of UCI payload 910 with a relatively large size 912, it is likely that PUCCH resource candidates with a short PUCCH format such as the PUCCH resource candidate-2 826 may not be applicable.

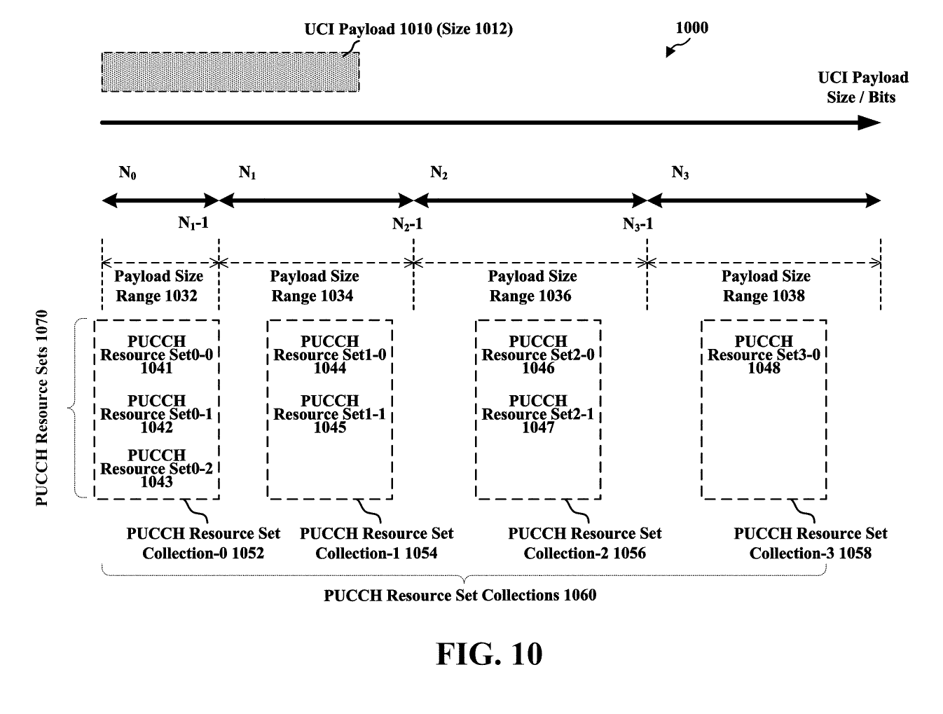

FIG. 10 is a diagram 1000 illustrating techniques of selecting a PUCCH resource candidate from multiple PUCCH resource sets. Similar to FIG. 9, a size 1012 of a UCI payload 1010 can be used to determine a collection of PUCCH resource sets. The base station 702 may configure the total payload size range into multiple (e.g., four) payload size ranges such as a payload size range 1032, a payload size range 1034, a payload size range 1036, and a payload size range 1038 having boundaries at N₀, N₁, N₂, N₃, and N₄ bits similar to what was described supra with respect to FIG. 9. In this example, multiple PUCCH resource set collections 1060 are configured to correspond to the multiple payload size ranges. For example, the payload size range 1032 is from N₀ to N₁−1, and the PUCCH resource set collection-0 1052 is configured for this payload size range 1032. Accordingly, when the UCI payload 1010 with a size 1012 is in the range of N₀ to N₁−1, the UE 704 selects the PUCCH resource set collection-0 1052 (from which a particular PUCCH resource set is further selected). The UE 704 can select a PUCCH resource set collection based on the size 1012 of the UCI payload 1010. The payload size range 1038 is all sizes equal to or larger than N₃, and the PUCCH resource set collection-3 1058 is configured for this payload size range 1038. Accordingly, when the UCI payload 1010 with a size 1012 is equal to or larger than N₃, the UE 704 selects the PUCCH resource set collection-3 1058.

For each of the four PUCCH resource set collections 1052 to 1058, there are one or more PUCCH resource sets 1070. For example, as shown in FIG. 10, the PUCCH resource set collection-0 1052 has three PUCCH resource sets: the PUCCH resource set0-0 1041, the PUCCH resource set0-1 1042, and the PUCCH resource set0-2 1043. It should be noted that a PUCCH resource set collection (e.g., the PUCCH resource set collection-3 1058) may only have one PUCCH resource set (e.g., the PUCCH resource set3-0 1048). In other words, the situation shown in FIG. 9 can be regarded as one special example of the situation shown in FIG. 10.

In this technique, the UE 704 selects a PUCCH resource set collection to the size 1012 of the UCI payload 1010. The UE 704 further select a particular PUCCH resource set from the collection according to other indications. For example, the UE 704 can select one PUCCH resource set from these PUCCH resource sets 1041 to 1043 in one PUCCH resource set collection-0 1052 based on certain indications. These indications can be carried explicitly in a radio resource control (RRC) message, a medium access control (MAC) control element information, or a Layer 1 (L1) signaling. These indications can also be carried explicitly in one another field in the DCI 722 or 723. For example, the base station 702 informs the UE 704 of an indication explicitly in an RRC message, and the UE can determine, based on the indication and the size 1012 of the UCI payload 1010, which PUCCH resource set to employ.

Further, the UE 704 can select one PUCCH resource set from multiple PUCCH resource sets 1041 to 1043 in one PUCCH resource set collection-0 1052 based on certain parameters implicitly. These parameters may be derived based on one or more of the following information: whether the data channel associated with the UCI payload is slot-based or non-slot-based (mini-slot-based) as illustrated in FIG. 7; a control resource set (CORESET) in which the DCI 722 or 723 for the UE 704 is transmitted; an index of a control channel element (CCE) of the CORESET in which the DCI 722 or 723 for the UE 704 is transmitted; and whether code block group (CBG) based HARQ acknowledge is enabled.

Similarly, for each set of the PUCCH resource sets 1041 to 1048, there may be multiple PUCCH resource candidates. For example, the PUCCH resource set0-0 1041 may have eight PUCCH resource candidates as shown in FIG. 8. The UE 704 may select one PUCCH resource candidate from those PUCCH resource candidates based on the DCI indicator 810.

Again, the UE 704 may receive a configuration from the base station 702, and the configuration may indicate the number of PUCCH resource set collections (e.g., four), the respective payload size ranges (e.g., the payload size ranges 1032 to 1038) thereof, the one or more PUCCH resource sets of each PUCCH resource set collection (e.g., the PUCCH resource set collection-0 1052), and the one or more PUCCH resource candidates of each PUCCH resource set (e.g., the PUCCH resource set0-0 1041). Based on the information in the configuration received from the base station 702, the UE 704 is capable of selecting which PUCCH resource set collection, which PUCCH resource set and which PUCCH resource candidate to employ.

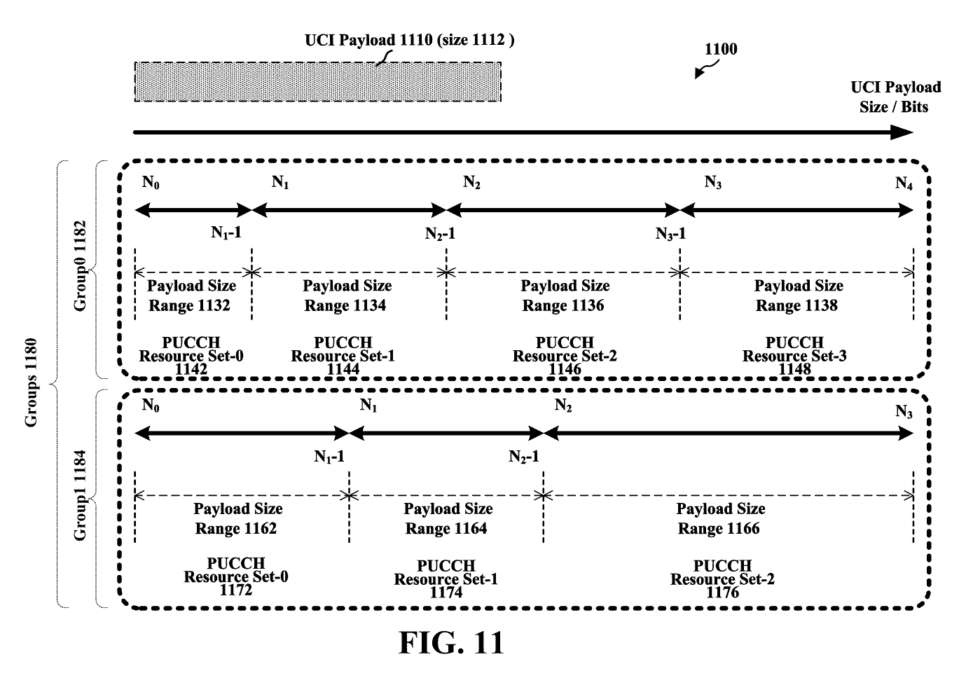

FIG. 11 is a diagram 1100 illustrating techniques of selecting a PUCCH resource candidate from multiple PUCCH resource sets. In this technique, the base station 702 may further configure multiple groups 1180 of PUCCH resource sets. For example, the base station 702 may configure two groups of PUCCH resource sets: the group0 1182 and the group1 1184. For each group, the base station 702 may configure PUCCH resource sets in the same way as in the technique shown in FIG. 9.

The UE 704 initially select a group from the groups 1180 based on certain indications. These indications may be derived based on the following information: whether the associated PDSCH assignment is slot-based or non-slot-based (mini-slot-based) as illustrated in FIG. 7; whether CBG based HARQ acknowledge is enabled; whether carrier aggregation (CA) is employed by the UE 704; and whether the UE 704 is in a fallback mode. For example, the UE 704 may select group0 1182 when the PDSCH assignment is slot-based.

Further, the number of PUCCH resource sets in each group of the groups 180 can be different. In this example, the group0 1182 has four PUCCH resource sets, and the group1 1184 has three PUCCH resource sets. Similarly, the division of payload size ranges in each group can be different. For example, the payload size ranges 1132 to 1138 and the payload size ranges 1162 to 1166 are different from each other.

After the UE 704 has selected a particular group, the UE 704 can further select a PUCCH resource set of the particular group based on a size 1112 of a UCI payload 1110. For group0 1182, the base station 702 may configure the total payload size range into multiple (e.g., four) payload size ranges such as the payload size range 1132, the payload size range 1134, the payload size range 1136 and payload size range 1138 having boundaries at N₀, N₁, N₂, N₃, and N₄. Multiple PUCCH resource sets correspond to the multiple payload size ranges. The UE 704 can select a PUCCH resource set from group0 1182 based on the size 1112 of the UCI payload 1110 as described supra.

Similarly, for group1 1184, the base station 702 may configure the total payload size range into multiple (e.g., three) payload size ranges such as the payload size range 1162, the payload size range 1164, and the payload size range 1166 having boundaries at N₀, N₁, N₂, and N₃. Multiple PUCCH resource sets correspond to the multiple payload size ranges. The UE 704 can select a PUCCH resource set from group1 1184 based on the size 1112 of the UCI payload 1110 as described supra.

Again, for each of the PUCCH resource sets 1142 to 1148 and 1172 to 1176, there may be multiple PUCCH resource candidates. For example, the PUCCH resource set0 1142 in the group0 1182 may have eight PUCCH resource candidates as shown in FIG. 8. Again, the UE 704 may receive a configuration from the base station 702, and the configuration may indicate the number of groups of PUCCH resource set (e.g., two), the number of PUCCH resource sets for each group, the respective payload size ranges (e.g., the payload size ranges 1032 to 1038 and 1162 to 1166), and the one or more PUCCH resource candidates of each PUCCH resource set (e.g., the PUCCH resource set-0 1142 of the group0 1182). Based on the information in the configuration received from the base station 702, the UE 704 can select which group, which PUCCH resource set and which PUCCH resource candidate to employ.

The technique illustrated in FIG. 11 can be combined with the technique illustrated in FIG. 10. In other words, the configuration from the base station 702 and received at the UE 704 can specify multiple groups 1180 of PUCCH resource sets. Each group of the multiple groups 1180 the base station 702 may include multiple PUCCH resource set collections 1060. Each collection of the multiple PUCCH resource set collections 1060 may include multiple PUCCH resource sets 1070. Each set of the multiple PUCCH resource sets 1070 may include multiple PUCCH resource candidates 820, 824, etc.

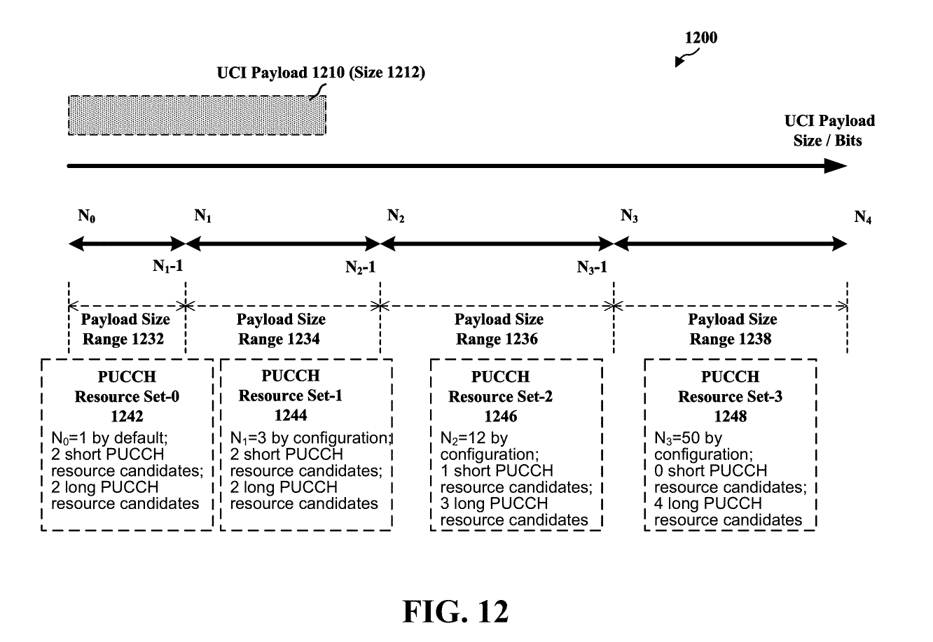

FIG. 12 is a diagram 1200 illustrating an embodiment of a technique to determine a PUCCH resource set. In this embodiment, the base station 702 configures four payload size ranges: the payload size range 1232, the payload size range 1234, the payload size range 1236, and the payload size range 1238 having boundaries at N₀, N₁, N₂, N₃, and N₄ bits. More specifically, N₀ is 1 by default, N₁ is 3, N₂ is 12, and N₃ is 50. N₄ may be infinity. For each of the four payload size ranges 1232 to 1238, only one PUCCH resource set is configured. Therefore, there are four PUCCH resource sets configured: the PUCCH resource set-0 1242, the PUCCH resource set-1 1244, the PUCCH resource set-2 1246, and the PUCCH resource set-3 1248. In this embodiment, for each of the four PUCCH resource sets, there are four PUCCH candidates. More specifically, for the PUCCH resource set-0 1242, there are two PUCCH candidates with a long PUCCH format and two PUCCH candidate with a short PUCCH format since the corresponding payload size range 1232 is from 1 bit to 2 bits which is relatively small. For the PUCCH resource set-1 1244, there are two PUCCH candidates with a long PUCCH format and two PUCCH candidate with a short PUCCH format since the corresponding payload size range 1234 is from 3 bits to 11 bits which is still relatively small. However, for the PUCCH resource set-2 1246, there are three PUCCH candidates with a long PUCCH format and only one PUCCH candidate with a short PUCCH format since the corresponding payload size range 1236 is from 12 bits to 49 bits which becomes larger. For the PUCCH resource set-3 1248, there are four PUCCH candidates with a long PUCCH format and no PUCCH candidate with a short PUCCH format since the corresponding payload size range 1238 is equal to or larger than 50 bits which may be too large for PUCCH candidate with a short PUCCH format. The UE 704 may select a particular PUCCH resource set in accordance with the techniques described supra referring to FIG. 9.

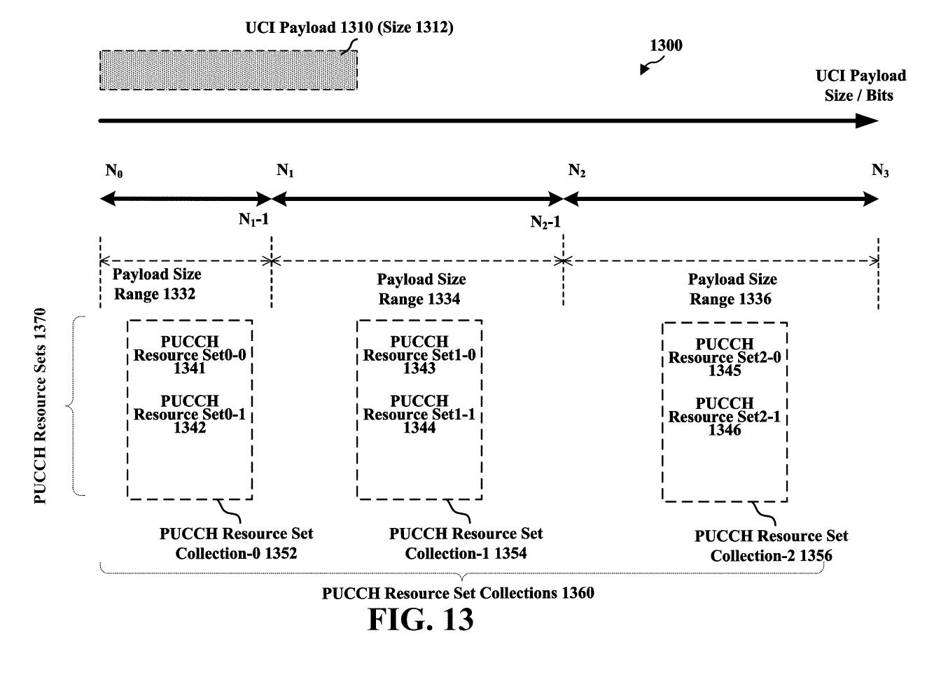

FIG. 13 is a diagram 1300 illustrating an embodiment of a technique to determine a PUCCH resource set. In this embodiment, the base station 702 configures three payload size ranges: the payload size range 1332, the payload size range 1334, and the payload size range 1336 having boundaries at N₀, N₁, N₂, and N₃ bits. For each of the three payload size ranges 1332 to 1336, one PUCCH resource set collection is configured. The PUCCH resource set collection-0 1352 is configured for the payload size range 1332, and has two PUCCH resource sets: the PUCCH resource set0-0 1341 and the PUCCH resource set0-1 1342. The PUCCH resource set collection-1 1354 is configured for the payload size range 1334, and has two PUCCH resource sets: the PUCCH resource set1-0 1343 and the PUCCH resource set1-1 1344. The PUCCH resource set collection-2 1356 is configured for the payload size range 1336, and has two PUCCH resource sets: the PUCCH resource set2-0 1345 and the PUCCH resource set2-1 1346. For each of the six PUCCH resource sets, there may be one or more PUCCH candidates.

In this embodiment, the UE 704 first select a PUCCH resource set collection from the three PUCCH resource set collections 1360 based on the size 1312 of the UCI payload 1310. Then within one PUCCH resource set collection, the UE 704 may select one PUCCH resource set from the two PUCCH resource sets 1370 based on certain indications. These indications can be carried explicitly in an RRC message, a MAC control element information, or a L1 signaling. These indications can also be carried explicitly in one another filed in the DCI 722 or 723, indicating which of the two PUCCH resource sets in one PUCCH resource set collection to be employ directly and dynamically. As such, the UE 704 may select a particular PUCCH resource set in accordance with the techniques described supra referring to FIG. 10.

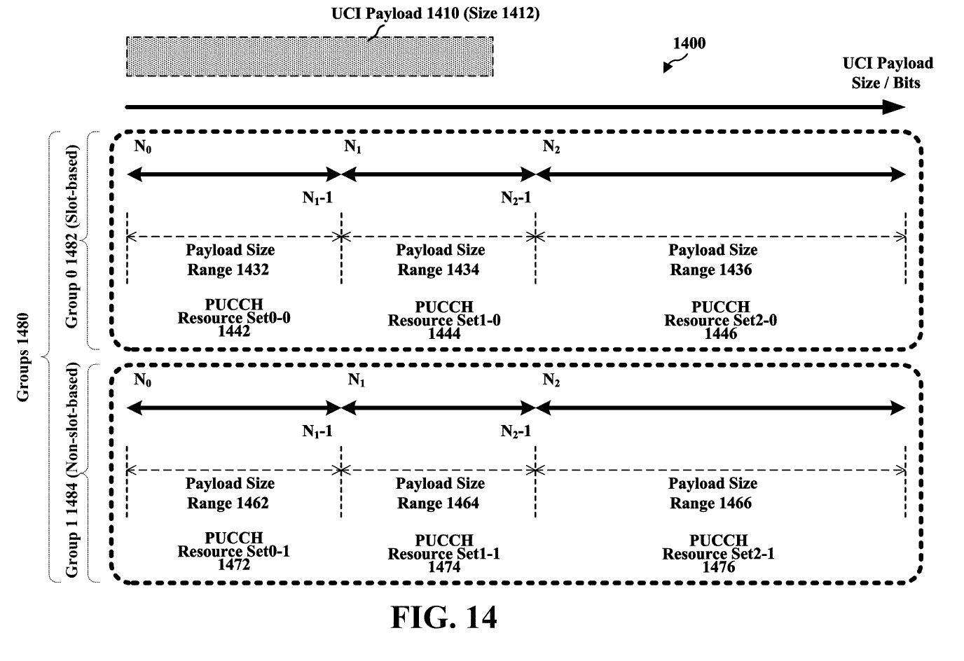

FIG. 14 is a diagram 1400 illustrating an embodiment of a technique to determine a PUCCH resource set. In this embodiment, the base station 702 configures two groups of PUCCH resource sets: the group0 1482 and the group1 1484. The group0 1482 is used when the data channel associated with the UCI payload is slot-based, while the group1 1484 is used when the data channel associated with the UCI payload is non-slot-based (mini-slot-based) as illustrated in FIG. 7. For each of the two groups 1480, the base station 702 configures three payload size ranges: the payload size range 1432, the payload size range 1434, the payload size range 1436, and the payload size range 1462, the payload size range 1464, the payload size range 1466, respectively. For each of the six payload size ranges, the base station 702 configures one PUCCH resource set (e.g., the PUCCH resource set0-0 1442). For each of the six PUCCH resource sets, there may be one or more PUCCH candidates. Moreover, for PUCCH resource sets in group1 1184 (i.e., in case of non-slot-based scheduling), the base station 702 may configure more PUCCH resource candidates with a short PUCCH format to reduce latency. In this embodiment, the UE 704 first selects between the group0 1482 and the group1 1484 based on whether the associated PDSCH assignment is slot-based or non-slot-based. Then the UE 704 selects one PUCCH resource set based on the size 1312 of the UCI payload 1310.

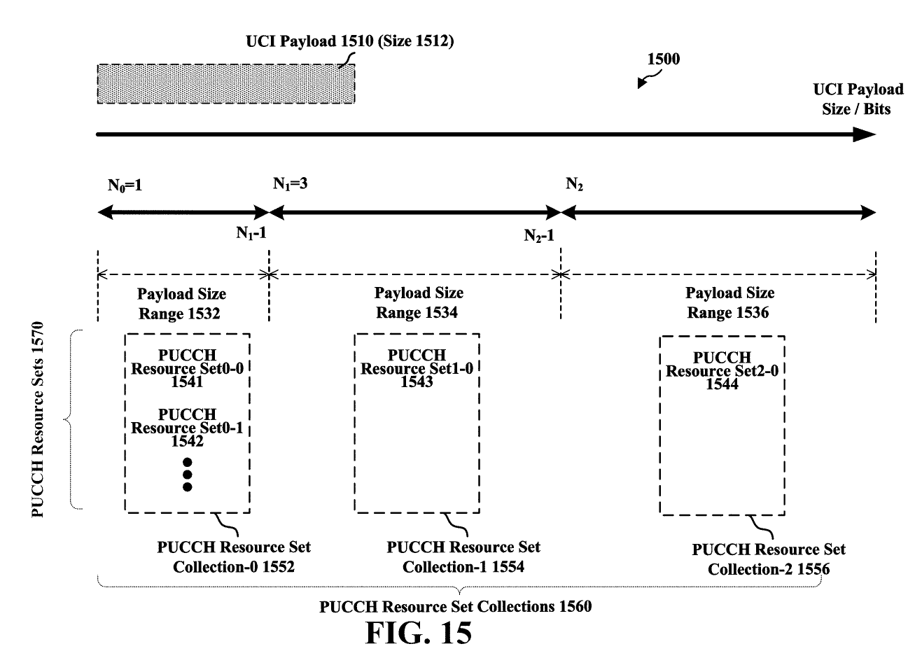

FIG. 15 is a diagram 1500 illustrating an embodiment of a technique to determine a PUCCH resource set. In this embodiment, the base station 702 configures three payload size ranges: the payload size range 1532, the payload size range 1534, and the payload size range 1536 having boundaries at N₀, N₁, N₂, and N₃ bits. For each of the three payload size ranges 1532 to 1536, the base station 702 configures one PUCCH resource set collection. For the payload size range 1532 which is from 1 bit to 2 bits, the base station 702 configures the PUCCH resource set collection-0 1552, and the PUCCH resource set collection-0 1552 has multiple PUCCH resource sets 1570. For the payload size ranges 1534 and 1536, the PUCCH resource set collection-1 1554 and the PUCCH resource set collection-2 1556 each have only one PUCCH resource set: the PUCCH resource set1-0 1543 and the PUCCH resource set2-0 1544, respectively. The UE 704 selects one PUCCH resource set from the PUCCH resource sets 1570 in the PUCCH resource set collection-0 1552 based on certain indications. These indicators can be another explicit indicator in the DCI 722 or 723. These indications can also be derived based on one or more of the following information: a control resource set (CORESET) in which the DCI 722 or 723 for the UE 704 is transmitted; a starting control channel element (CCE) index (or an ending CCE index, an aggregation level) of the CORESET in which the DCI 722 or 723 for the UE 704 is transmitted and so on.

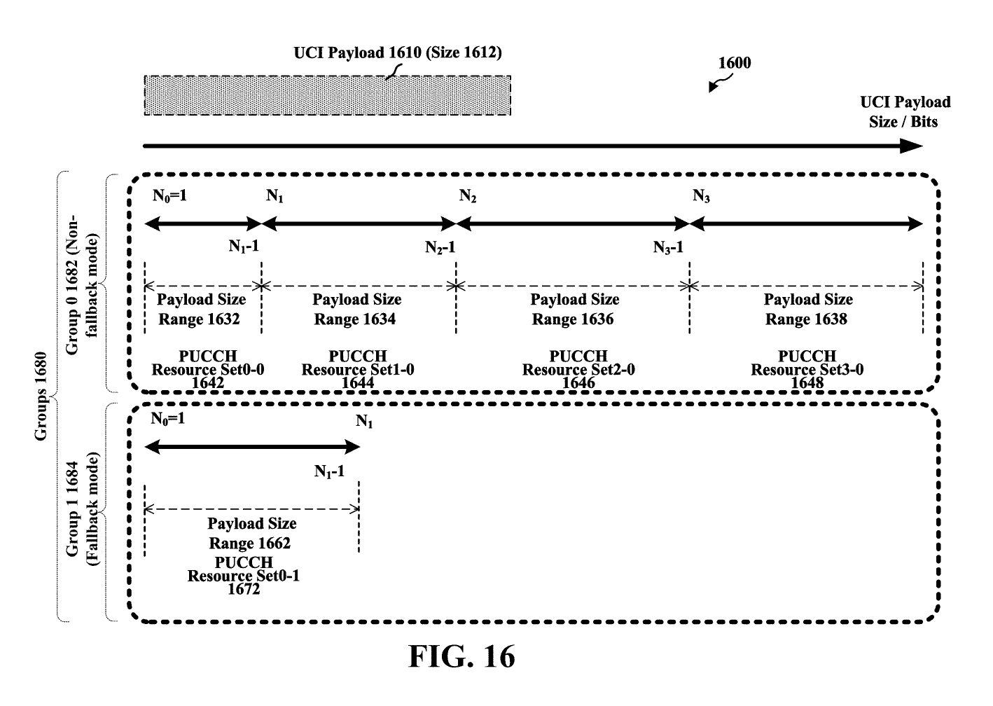

FIG. 16 is a diagram 1600 illustrating an embodiment of a technique to determine a PUCCH resource set. In this embodiment, the base station 702 configures two groups of PUCCH resource sets: the group0 1682 and the group1 1684. The group0 1682 is used when the UE 704 is in a non-fallback mode, while the group1 1684 is used when the UE 704 is in a fallback mode. Alternatively, the group0 1682 is used when the UE 704 is not in initial access state, while the group1 1684 is used when the UE 704 is during initial access. For each of the two groups 1680, the base station 702 configures one or more payload size ranges. More specifically, the base station 702 configures four payload size ranges for the group0 1682: the payload size range 1632, the payload size range 1634, the payload size range 1636, and the payload size range 1638. For each of the four payload size ranges, the base station 702 configures one PUCCH resource set (e.g., the PUCCH resource set0-0 1642). On the other hand, the base station 702 configures only one payload size range for the group1 1684: the payload size range 1662, because it is likely that only limited UCI is transmitted in a fallback mode. The base station 702 configures one PUCCH resource set: the PUCCH resource set0-1 1672. In this embodiment, the group0 1682 and the group1 1684 have different numbers of payload size ranges and different payload size ranges. In this embodiment, the UE 704 first selects between the group0 1682 and the group1 1684 based on whether the UE 704 is in a non-fallback mode or a fallback mode (or alternatively, whether the UE 704 is during initial access or not in initial access state). Then the UE 704 selects one PUCCH resource set based on the size 1612 of the UCI payload 1610. As such, the UE 704 may select a particular PUCCH resource set in accordance with the techniques described supra referring to FIG. 11.

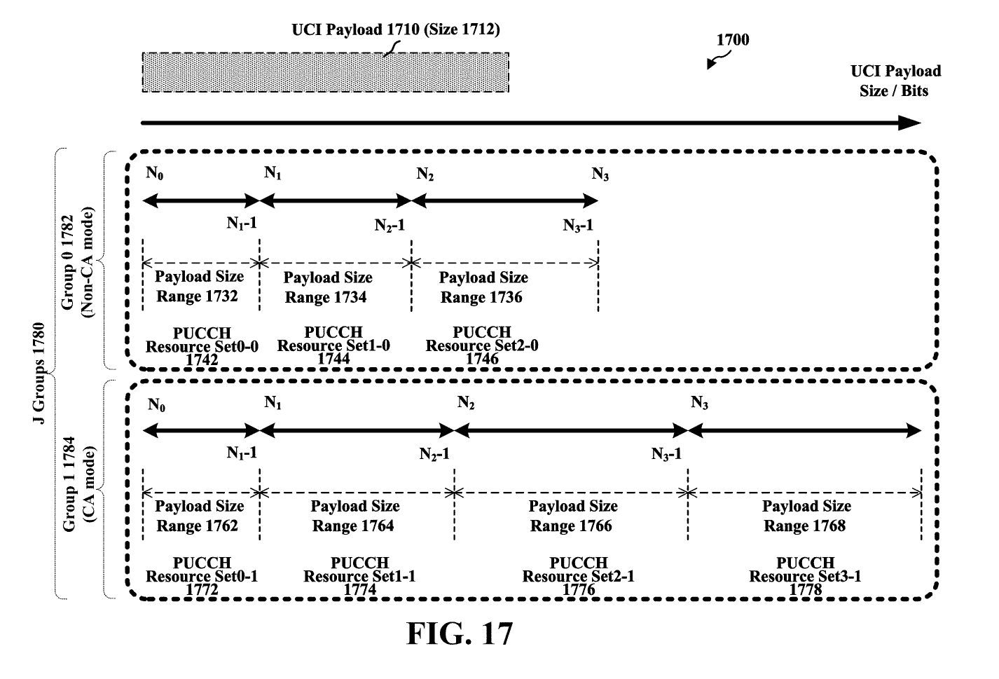

FIG. 17 is a diagram 1700 illustrating an embodiment of a technique to determine a PUCCH resource set. In this embodiment, the base station 702 configures two groups of PUCCH resource sets: the group0 1782 and the group1 1784. The group0 1782 is used when the UE 704 does not employ carrier aggregation (CA), while the group1 1784 is used when the UE 704 employs carrier aggregation (CA). Alternatively, the group0 1782 is used when the CBG based HARQ acknowledge feedback is not enabled, while the group1 1784 is used when the CBG based HARQ acknowledge feedback is enabled. For each of the two groups 1680, the base station 702 configures one or more payload size ranges. More specifically, the base station 702 configures three payload size ranges for the group0 1782: the payload size range 1732, the payload size range 1734, and the payload size range 1736. For each of the three payload size ranges, the base station 702 configures one PUCCH resource set (e.g., the PUCCH resource set0-0 1742). On the other hand, the base station 702 configures four payload size ranges for the group1 1784: the payload size range 1762, the payload size range 1734, the payload size range 1736, and the payload size range 1738. Since carrier aggregation (CA) or CBG based HARQ acknowledge feedback may require much larger size 1712 of the UCI payload 1710, the payload size ranges in the group1 1784 are relatively larger than those in the group0 1782. For each of the four payload size ranges, the base station 702 configures one PUCCH resource set (e.g., the PUCCH resource set0-1 1772). In this embodiment, the group0 1682 and the group1 1684 have different numbers of payload size ranges and different payload size ranges. In this embodiment, the UE 704 first selects between the group0 1682 and the group1 1684 based on whether the UE 704 employs CA or not (or alternatively, whether the CBG based HARQ acknowledge feedback is enabled or not). Then the UE 704 selects one PUCCH resource set based on the size 1712 of the UCI payload 1710. As such, the UE 704 may select a particular PUCCH resource set in accordance with the techniques described supra referring to FIG. 11.

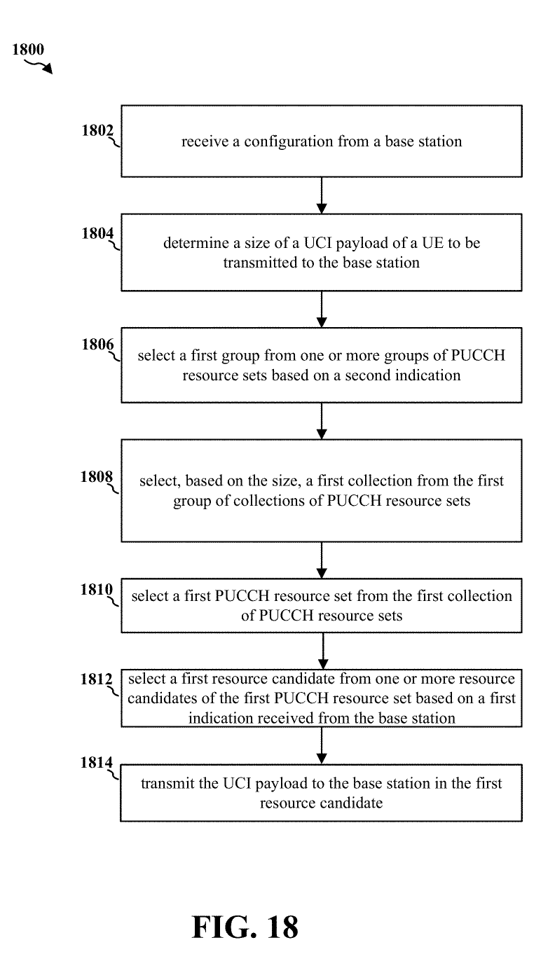

FIG. 18 is a flow chart 1800 illustrating a method (process) of determining a set PUCCH resource set. The method may be performed by a UE (e.g., the UE 704, the apparatus 1902/1902′). At operation 1802, the UE 704 receive a configuration from a base station (e.g., the base station 702). The configuration indicates the first group (e.g., the group0 1182) of collections (e.g., the PUCCH resource set collections 1060) of PUCCH resource sets (e.g., the PUCCH resource set0-0 1041), the respective different UCI payload size range (e.g., the payload size range 1032) corresponding to each collection of the first group of collections, and the one or more resource candidates (e.g., the PUCCH resource candidate 822) of each PUCCH resource set. In certain configurations, the first group (e.g., the group0 1182) of collections including M collections (e.g., the PUCCH resource set collections 1060), wherein a total UCI payload size range is divided into M sections (e.g., the payload size range 1032, the payload size range 1034, the payload size range 1036, and the payload size range 1038) corresponding to the M collections, respectively, M being an integer greater than 0 (e.g., 4).

At operation 1804, the UE determines a size (e.g., the UCI payload size 912) of a UCI payload (e.g., the UCI payload 910) of the UE (e.g., the UE 704) to be transmitted to the base station (e.g., the base station 702).

At operation 1806, the UE selects the first group from one or more groups of PUCCH resource sets based on a second indication. In certain configurations, the second indication is derived based on one or more of: whether a data channel associated with the UCI payload is slot-based; whether CBG based HARQ-ACK feedback is enabled; whether CA is employed by the UE; and whether the UE is in a fallback mode.

At operation 1808, the UE selects, based on the size, a first collection (e.g., the PUCCH resource set collection-0 1052) from a first group (e.g., the group0 1182) of collections of PUCCH resource sets. Each collection of the first group of collections corresponds to a respective different UCI payload size range (e.g., the payload size range 1032, the payload size range 1034, the payload size range 1036, and the payload size range 1038), and each PUCCH resource set (the PUCCH resource set0-0 1041) includes one or more resource candidates (e.g., the PUCCH resource candidate 822).

At operation 1810, the UE selects a first PUCCH resource set (e.g., the PUCCH resource set0-0 1041) from the first collection (e.g., the PUCCH resource set collection-0 1052) of PUCCH resource sets. In certain configurations, the first PUCCH resource set is selected from the first collection of PUCCH resource sets based on a second indication. In certain configurations, the second indication is carried in one or more of: an RRC message; a MAC control element information; a Layer 1 (L1) signaling; and a field in the DCI. In certain configurations, the second indication is derived based on one or more of: whether a data channel associated with the UCI payload is slot-based; a CORESET in which the DCI for the UE is transmitted; an index of a CCE of the CORESET in which the DCI for the UE is transmitted; whether CBG based HARQ-ACK feedback is enabled.

At operation 1812, the UE selects a first resource candidate (e.g., the PUCCH resource candidate 822) from one or more resource candidates (e.g., the set of PUCCH resource candidates 820, 824, etc.) of the first PUCCH resource set based on a first indication received from the base station. In certain configurations, the first indication is carried in a DCI (e.g., the DCI 722 or 723). In certain configurations, each resource candidate of the one or more resource candidates of the first PUCCH resource set is defined by: an allocation of one or more physical resource blocks (e.g., the physical resource block 830) containing resources elements constituting the each resource candidate; time domain duration and position of the resource elements; and a PUCCH format used on the resource elements.

At operation 1812, the UE transmits the UCI payload (e.g., the UCI payload 910) to the base station in the first resource candidate (e.g., the PUCCH resource candidate 822).

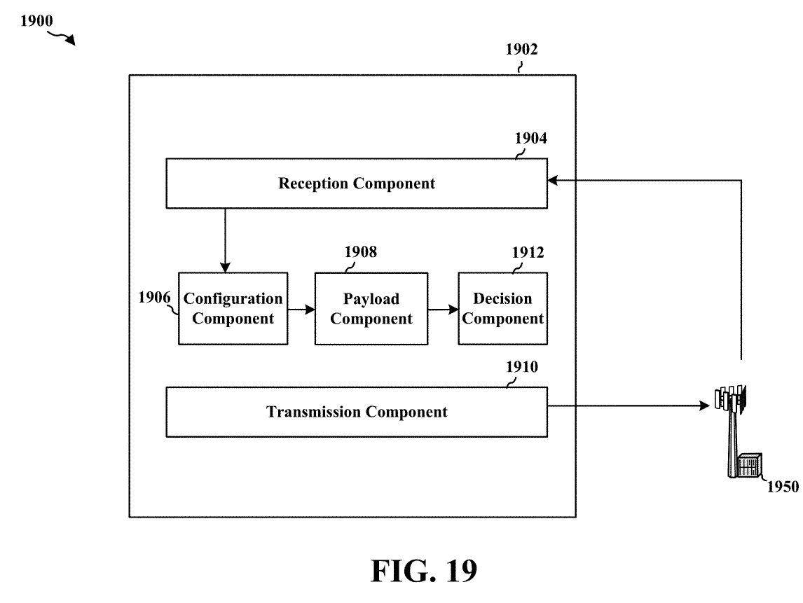

FIG. 19 is a conceptual data flow diagram 1900 illustrating the data flow between different components/means in an exemplary apparatus 1902. The apparatus 1902 may be a UE. The apparatus 1902 includes a reception component 1904, a configuration component 1906, a payload component 1908, a decision component 1912, and a transmission component 1910.

The configuration component 1906 receives a configuration from a base station (e.g., the base station 702). The configuration indicates the first group (e.g., the group0 1182) of collections (e.g., the PUCCH resource set collections 1060) of PUCCH resource sets (e.g., the PUCCH resource set0-0 1041), the respective different UCI payload size range (e.g., the payload size range 1032) corresponding to each collection of the first group of collections, and the one or more resource candidates (e.g., the PUCCH resource candidate 822) of each PUCCH resource set. In certain configurations, the first group (e.g., the group0 1182) of collections including M collections (e.g., the PUCCH resource set collections 1060), wherein a total UCI payload size range is divided into M sections (e.g., the payload size range 1032, the payload size range 1034, the payload size range 1036, and the payload size range 1038) corresponding to the M collections, respectively, M being an integer greater than 0 (e.g., 4).

The payload component 1908 determines a size (e.g., the UCI payload size 912) of a UCI payload (e.g., the UCI payload 910) of the UE (e.g., the UE 704) to be transmitted to the base station (e.g., the base station 702).

The decision component 1912 selects the first group from one or more groups of PUCCH resource sets based on a second indication. In certain configurations, the second indication is derived based on one or more of: whether a data channel associated with the UCI payload is slot-based; whether CBG based HARQ-ACK feedback is enabled; whether CA is employed by the UE; and whether the UE is in a fallback mode.

The decision component 1912 selects, based on the size, a first collection (e.g., the PUCCH resource set collection-0 1052) from a first group (e.g., the group0 1182) of collections of PUCCH resource sets. Each collection of the first group of collections corresponds to a respective different UCI payload size range (e.g., the payload size range 1032, the payload size range 1034, the payload size range 1036, and the payload size range 1038), and each PUCCH resource set (the PUCCH resource set0-0 1041) includes one or more resource candidates (e.g., the PUCCH resource candidate 822).

The decision component 1912 selects a first PUCCH resource set (e.g., the PUCCH resource set0-0 1041) from the first collection (e.g., the PUCCH resource set collection-0 1052) of PUCCH resource sets. In certain configurations, the first PUCCH resource set is selected from the first collection of PUCCH resource sets based on a second indication. In certain configurations, the second indication is carried in one or more of: an RRC message; a MAC control element information; a Layer 1 (L1) signaling; and a field in the DCI. In certain configurations, the second indication is derived based on one or more of: whether a data channel associated with the UCI payload is slot-based; a CORESET in which the DCI for the UE is transmitted; an index of a CCE of the CORESET in which the DCI for the UE is transmitted; whether CBG based HARQ-ACK feedback is enabled.

The decision component 1912 selects a first resource candidate (e.g., the PUCCH resource candidate 822) from one or more resource candidates (e.g., the set of PUCCH resource candidates 820, 824, etc.) of the first PUCCH resource set based on a first indication received from the base station. In certain configurations, the first indication is carried in a DCI (e.g., the DCI 722 or 723). In certain configurations, each resource candidate of the one or more resource candidates of the first PUCCH resource set is defined by: an allocation of one or more physical resource blocks (e.g., the physical resource block 830) containing resources elements constituting the each resource candidate; time domain duration and position of the resource elements; and a PUCCH format used on the resource elements.

The transmission component 1910 transmits the UCI payload (e.g., the UCI payload 910) to the base station in the first resource candidate (e.g., the PUCCH resource candidate 822).

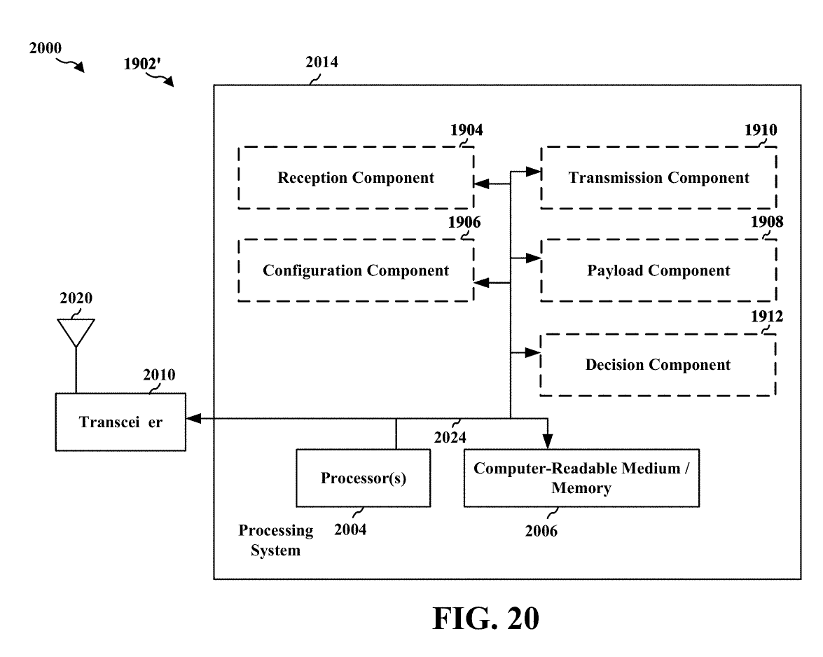

FIG. 20 is a diagram 2000 illustrating an example of a hardware implementation for an apparatus 1902′ employing a processing system 2014. The apparatus 1902′ may be a UE. The processing system 2014 may be implemented with a bus architecture, represented generally by a bus 2024. The bus 2024 may include any number of interconnecting buses and bridges depending on the specific application of the processing system 2014 and the overall design constraints. The bus 2024 links together various circuits including one or more processors and/or hardware components, represented by one or more processors 2004, the reception component 1904, the configuration component 1906, the payload component 1908, the transmission component 1910, the decision component 1912, and a computer-readable medium/memory 2006. The bus 2024 may also link various other circuits such as timing sources, peripherals, voltage regulators, and power management circuits, etc.

The processing system 2014 may be coupled to a transceiver 2010, which may be one or more of the transceivers 254. The transceiver 2010 is coupled to one or more antennas 2020, which may be the communication antennas 252.

The transceiver 2010 provides a means for communicating with various other apparatus over a transmission medium. The transceiver 2010 receives a signal from the one or more antennas 2020, extracts information from the received signal, and provides the extracted information to the processing system 2014, specifically the reception component 1904. In addition, the transceiver 2010 receives information from the processing system 2014, specifically the transmission component 1910, and based on the received information, generates a signal to be applied to the one or more antennas 2020.

The processing system 2014 includes one or more processors 2004 coupled to a computer-readable medium/memory 2006. The one or more processors 2004 are responsible for general processing, including the execution of software stored on the computer-readable medium/memory 2006. The software, when executed by the one or more processors 2004, causes the processing system 2014 to perform the various functions described supra for any particular apparatus. The computer-readable medium/memory 2006 may also be used for storing data that is manipulated by the one or more processors 2004 when executing software. The processing system 2014 further includes at least one of the reception component 1904, the configuration component 1906, the payload component 1908, the transmission component 1910, and the decision component 1912. The components may be software components running in the one or more processors 2004, resident/stored in the computer readable medium/memory 2006, one or more hardware components coupled to the one or more processors 2004, or some combination thereof. The processing system 2014 may be a component of the UE 250 and may include the memory 260 and/or at least one of the TX processor 268, the RX processor 256, and the communication processor 259.

In one configuration, the apparatus 1902/apparatus 1902′ for wireless communication includes means for performing each of the operations of FIG. 18. The aforementioned means may be one or more of the aforementioned components of the apparatus 1902 and/or the processing system 2014 of the apparatus 1902′ configured to perform the functions recited by the aforementioned means.

As described supra, the processing system 2014 may include the TX Processor 268, the RX Processor 256, and the communication processor 259. As such, in one configuration, the aforementioned means may be the TX Processor 268, the RX Processor 256, and the communication processor 259 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
determining a size of an uplink control information (UCI) payload of the UE to be transmitted to a base station;
selecting, based on the size, a first collection from a first group of collections of physical uplink control channel (PUCCH) resource sets, each collection of the first group of collections corresponding to a respective different UCI payload size range, each PUCCH resource set including one or more resource candidates;
selecting a first PUCCH resource set from the first collection of PUCCH resource sets;
selecting a first resource candidate from one or more resource candidates of the first PUCCH resource set based on a first indication received from the base station; and
transmitting the UCI payload to the base station in the first resource candidate.

2. The method of claim 1, wherein the first indication is carried in downlink control information (DCI).

3. The method of claim 1, wherein the first PUCCH resource set is selected from the first collection of PUCCH resource sets based on a second indication.

4. The method of claim 3, wherein the second indication is carried in one or more of:
a radio resource control (RRC) message,
a medium access control (MAC) control element information,
a Layer 1 (L1) signaling, and
a field in downlink control information (DCI).

5. The method of claim 3, wherein the second indication is derived based on one or more of:
whether a data channel associated with the UCI payload is slot-based,
a control resource set (CORESET) in which downlink control information (DCI) for the UE is transmitted,
an index of a control channel element (CCE) of the CORESET in which DCI for the UE is transmitted, and
whether code block group (CBG) based hybrid automatic repeat request acknowledgement (HARQ-ACK) feedback is enabled.

6. The method of claim 1, wherein each resource candidate of the one or more resource candidates of the first PUCCH resource set is defined by:
an allocation of one or more physical resource blocks containing resources elements constituting the each resource candidate,
time domain duration and position of the resource elements, and
a PUCCH format used on the resource elements.

7. The method of claim 1, further comprising:
receiving a configuration from the base station, the configuration indicating: the first group of collections of PUCCH resource sets, the respective different UCI payload size range corresponding to each collection of the first group of collections, and the one or more resource candidates of each PUCCH resource set.

8. The method of claim 1, further comprising:
selecting the first group from one or more groups of PUCCH resource sets based on a second indication.

9. The method of claim 8, wherein the second indication is derived based on one or more of:
whether a data channel associated with the UCI payload is slot-based,
whether code block group (CBG) based hybrid automatic repeat request acknowledgement (HARQ-ACK) feedback is enabled,
whether carrier aggregation (CA) is employed by the UE, and
whether the UE is in a fallback mode.

10. The method of claim 1, wherein the first group of collections including M collections, wherein a total UCI payload size range is divided into M sections corresponding to the M collections, respectively, M being an integer greater than 0.

11. An apparatus for wireless communication, the apparatus being a user equipment (UE), comprising:
a memory; and
at least one processor coupled to the memory and configured to:
determine a size of an uplink control information (UCI) payload of the UE to be transmitted to a base station;
select, based on the size, a first collection from a first group of collections of physical uplink control channel (PUCCH) resource sets, each collection of the first group of collections corresponding to a respective different UCI payload size range, each PUCCH resource set including one or more resource candidates;
select a first PUCCH resource set from the first collection of PUCCH resource sets;
select a first resource candidate from one or more resource candidates of the first PUCCH resource set based on a first indication received from the base station; and
transmit the UCI payload to the base station in the first resource candidate.

12. The apparatus of claim 11, wherein the first indication is carried in downlink control information (DCI).

13. The apparatus of claim 11, wherein the first PUCCH resource set is selected from the first collection of PUCCH resource sets based on a second indication.

14. The apparatus of claim 13, wherein the second indication is carried in one or more of:
a radio resource control (RRC) message,
a medium access control (MAC) control element information,
a Layer 1 (L1) signaling, and
a field in downlink control information (DCI).

15. The apparatus of claim 13, wherein the second indication is derived based on one or more of:
whether a data channel associated with the UCI payload is slot-based,
a control resource set (CORESET) in which downlink control information (DCI) for the UE is transmitted,
an index of a control channel element (CCE) of the CORESET in which DCI for the UE is transmitted, and
whether code block group (CBG) based hybrid automatic repeat request acknowledgement (HARQ-ACK) feedback is enabled.

16. The apparatus of claim 11, wherein each resource candidate of the one or more resource candidates of the first PUCCH resource set is defined by:
an allocation of one or more physical resource blocks containing resources elements constituting the each resource candidate,
time domain duration and position of the resource elements, and
a PUCCH format used on the resource elements.

17. The apparatus of claim 11, wherein the at least one processor is further configured to:
receive a configuration from the base station, the configuration indicating: the first group of collections of PUCCH resource sets, the respective different UCI payload size range corresponding to each collection of the first group of collections, and the one or more resource candidates of each PUCCH resource set.

18. The apparatus of claim 11, wherein the at least one processor is further configured to:
select the first group from one or more groups of PUCCH resource sets based on a second indication.

19. The apparatus of claim 11, wherein the first group of collections including M collections, wherein a total UCI payload size range is divided into M sections corresponding to the M collections, respectively, M being an integer greater than 0.

20. A computer-readable medium storing computer executable code for wireless communication of a user equipment (UE), comprising code to:
determine a size of an uplink control information (UCI) payload of the UE to be transmitted to a base station;
select, based on the size, a first collection from a first group of collections of physical uplink control channel (PUCCH) resource sets, each collection of the first group of collections corresponding to a respective different UCI payload size range, each PUCCH resource set including one or more resource candidates;
select a first PUCCH resource set from the first collection of PUCCH resource sets;
select a first resource candidate from one or more resource candidates of the first PUCCH resource set based on a first indication received from the base station; and
transmit the UCI payload to the base station in the first resource candidate.
